(19) United States
(12) Patent Application Publication
(10) Pub. No.: US 2025/0007699 A1
(43) Pub. Date: Jan. 2, 2025

(54) COMPUTER-IMPLEMENTED METHOD FOR COMPUTING UNBALANCED L-TREES EFFICIENTLY FOR HASH-BASED SIGNATURES USED IN POST-QUANTUM CRYPTOGRAPHIC AUTHENTICATION

(71) Applicant: PQSECURE TECHNOLOGIES, LLC, Boca Raton, FL (US)

(72) Inventor: Furkan KARABULUT, Raleigh, NC (US)

(73) Assignee: PQSECURE TECHNOLOGIES, LLC, Boca Raton, FL (US)

(21) Appl. No.: 18/572,915

(22) PCT Filed: Jun. 30, 2023
(86) PCT No.: PCT/US23/26686

§ 371 Date: Dec. 21, 2023

(51) Int. Cl. H04L 9/08; H04L 9/32

(52) U.S. Cl. CPC H04L 9/0852; H04L 9/3236; H04L 9/3247

(57) ABSTRACT

A computer-implemented method for computing an unbalanced L-tree for hash-based signatures used in post-quantum cryptographic authentication that includes providing a computer with at least one processor operably configured to carry out a post-quantum cryptographic authentication session and having computer-readable instructions to generate a root of an unbalanced L-tree in the post-quantum cryptographic authentication session, computing a maximum 2ⁿ number of leaf node pairs formed on the unbalanced L-tree and hashing each pair of adjacent leaf nodes forming the maximum 2ⁿ number of leaf node pairs with a stacked-based root implementation until reaching an unpaired stacked node output, and subjecting remaining leaf nodes formed on the unbalanced L-tree with an L-tree-based root implementation and computing the remaining leaf nodes with the unpaired stacked node output to generate the root of the unbalanced L-tree formed as part of the post-quantum cryptographic authentication session.

### FIELD OF THE INVENTION

The present invention relates generally to methods and systems directed toward post-quantum cryptographic authentication and, more particularly, relates to post-quantum cryptographic authentication methods and systems with stateful hash-based signatures known as the Extended Merkle Signature Scheme (XMSS).

### BACKGROUND OF THE INVENTION

Cryptography is a key backbone of many processing systems and generally functions to secure electronic communications utilizing various hard mathematical problems. More specifically, deploying cryptosystems in digital devices achieves essential information security properties including data confidentiality, data integrity, authentication, and non-repudiation. Authentication is provided through digital signatures. Current classical digital signatures such as Rivest-Shamir-Adleman (RSA) and Elliptic Curve Digital Signature (ECDSA) are subject to significant drawbacks due to their higher likelihood of being broken by cryptographically relevant large-scale quantum computers. XMSS belongs to a family of quantum-safe stateful hash-based signatures used for authentication. It has the smallest signatures out of such schemes and comes with a multi-tree variant that solves the technical problem of slow key generation. Moreover, XMSS is secure, making only mild assumptions on the underlying hash function. One of the main advantages of XMSS is that it does not rely on the collision resistance of the used hash functions, but rather relies on weaker properties. XMSS is a stateful signature scheme, meaning that the private key changes with every signature generation.

A main principle associated with cryptography is passing a secret through hash chains and then generating a public key. Cryptography has three routines: Key generation, signature generation, and verification. The key generation first gets a secret seed and then extends it to a secret key. Second, it passes the secret key through hash chains and then generates a public key, which is also called root. The signature generation follows the same steps but does not complete the hash chain until the root generation. It completes the chain with the length of the message and the output of the completed chain is called the signature.

The verification routine gets the signature and then feeds the chain as the input, but it does not start from the beginning, it starts from the chain step where the signature is left. When the chain is completed, the verification routine obtains a root. The verification returns true if the obtained root is the same as the public key. Otherwise, it returns false. The process requires a lot of memory access and hence memory efficient implementations of XMSS may find utility in computer-based secure quantum-safe communication systems and methods.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments further and explain various principles and advantages all in accordance with the present invention.

FIG. 1 is a diagram depicting a prior art XMSS body having three sub-modules: WOTS instances (WOTS chain), L-trees and Merkle tree;

FIG. 2 is a diagram depicting a prior art balanced tree whose height is three and whose leaf number is 8;

FIG. 3 is a table illustrating the memory usage sequence to generate the root of an unbalanced tree with a prior art, classic, approach;

FIG. 4 is a diagram depicting memory usage and an operation sequence for a prior art stack-based implementation method that can be used only when the given tree has a balanced structure;

FIG. 5 is a diagram depicting why prior art stack-based implementation cannot functionally work when the tree has an unbalanced structure;

FIG. 6 is a table depicting the memory usage sequence in connection with a method of computing L-trees efficiently for hash-based signatures and by partially employing stack-based implementation; and

FIG. 7 is a process flow diagram depicting a computer-implemented method for computing an unbalanced L-tree for hash-based signatures used in post-quantum cryptographic authentication in accordance with one embodiment of the present invention.

### SUMMARY OF THE INVENTION

The invention provides an architecture and method for efficiently computing L-tree. An L-tree is an unbalanced binary hash tree. L-tree is a major operation that combines a Winternitz one-time signature (WOTS) public key components and produces a single n-byte value. In XMSS, the largest L-tree has 67 leaves. This corresponds to a 128-bit post-quantum security level in which there are 67 public key components based on the secure hash algorithms (SHA) computed in an input block. Here, we define an “efficient” implementation of an L-tree as one that requires less memory space than the state-of-the-art or prior art, which requires 67 locations. The architecture and methodology described herein addresses this issue by providing a method to reduce memory locations for post-quantum XMSS based signing and verification. In what follows we explain the main operations in XMSS to provide meaningful explanation for the invention herein.

The XMSS hash chain consists of three hash trees: (i) a WOTS chain (or tree), (ii) a L-tree, and (iii) a Merkle tree. The first operation (WOTS tree) is configured to receive one of these three commands: Key generation, signature generation, and the verification. The key generation and the signature generation extend a secret seed to the secret keys. The key generation computes WOTS public keys by completing the full WOTS chain by starting with the secret keys, while the signature generation does not require full completion, unlike key generation, yet it completes the w-step in the chain, where w is the length of the message and the output of the chain is the signature. The last command, verification, computes the full chain by starting the step where the signature generation stops. Therefore, it receives the signature as input and completes the full WOTs chain, and generates the public keys. If the signature is generated from the secret key, the verification output public keys should match the key generation public keys.

The second major operation is an L-tree which receives the WOTS chain outputs, and WOTS public keys and then computes an L-tree root in a binary tree format. The XMSS has two configurations such that the WOTS public key could have 67 or 51 members. Therefore, the L-tree can have either 67 or 51 leaves. Since these leaf numbers are not a power of two, the L-tree is called an unbalanced tree. Finally, the L-tree generates one root from these leaves.

The third major operation is a tree-hash operation based on the Merkle tree format which receives a number of L-tree roots as the input and tree leaves. NIST recommends three different configurations for the XMSS, which determines the number of L-trees. The configurations are the Merkle tree parameters and can be 10, 16, and 20. Based on these parameters, L-tree number can be 1,024 (2\hat{ }10), 65,536 (2\hat{ }16), or 1,048,576 (2\hat{ }20).

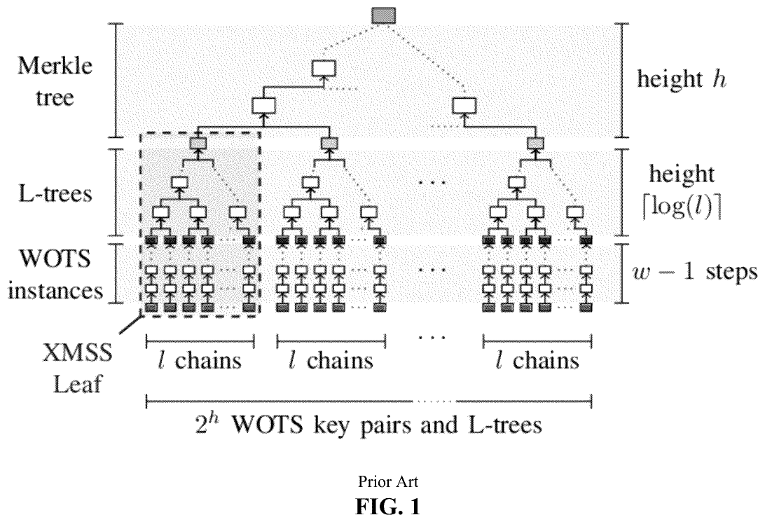

With reference to FIG. 1, a diagram depicting a prior-art XMSS tree is depicted for background context of invention. In this context, inefficiencies in the L-tree structure require an optimization solution, which is what the present invention addresses. Each WOTS instance has l number of independent chains, and each instance generates one L-tree's leaves. Therefore, each L-tree has l number of leaves. Each L-tree creates a root in a binary tree form, and which is at the top of an L-tree. The L-trees' roots are the leaves of Merkle tree. There are 2^{h} L-Trees hence Merkle tree has 2^{h} leaves. These leaves are used to generate the root of Merkle tree, like L-tree.

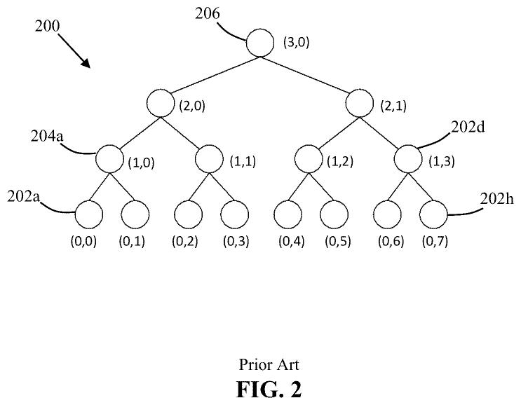

With reference to FIG. 2, the exemplary prior art L-tree 200 is a binary tree structure that is considered balanced. Since the L-tree height is three, it has eight leaves (labeled as 202a-h). The L-tree 200 receives its leaves from the WOTS tree and then computes their parent nodes (labeled as 204a-d) by hashing two child nodes until obtaining the final parent (labeled as 206), whose height is three. There are two prior art implementation strategies to obtain the final parent 206.

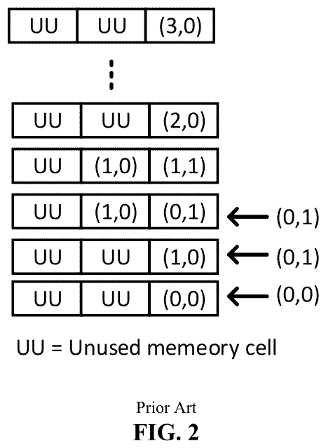

With reference to FIG. 3, said figure depicts a memory usage sequence to generate the root of an unbalanced exemplary L-tree-based implementation. The tree first allocates a memory location of the same size as all tree leaves. Since the tree has eight leaves, there are eight memory cells. Then, it stores all the leaves for their corresponding memory locations as shown in Stage 1. Following stages, two adjacent memory locations pass through a hash operation and generate parent(s). As seen, this implementation requires a large memory space and after the first stage, there are many unused memory locations (illustrated by UU) which makes this method to be inefficient.

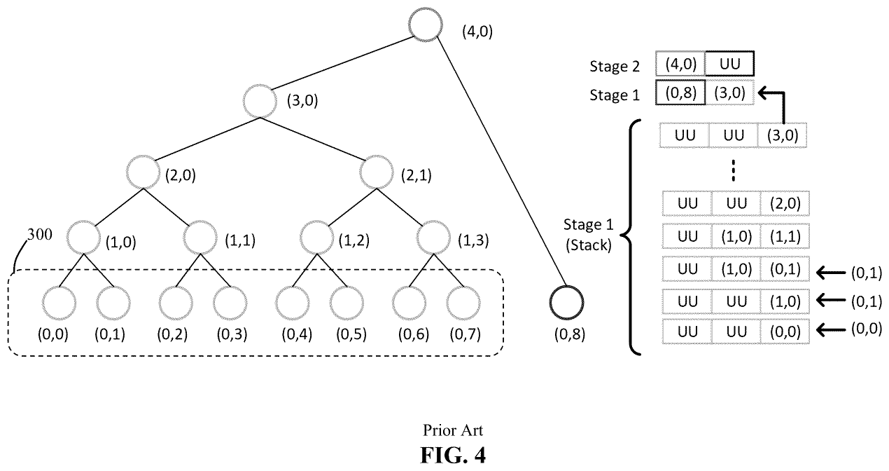

With reference to FIG. 4, said figure depicts a memory usage and an operation sequence and presents the root generation from leaves method with a stack structure. This known method requires a memory size with a depth of tree height (3). This stack has last-in-first-out (LIFO) functionality. It gets leaves one by one. If the two adjacent stack members have the same height, it first pops these two, then hashes them, and finally writes the result back to the stack.

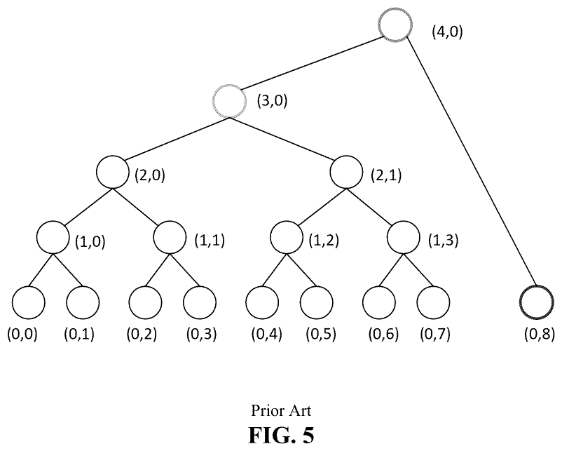

Although the stack-based solution or implementation provides a more memory-efficient solution, it does not work for unbalanced trees, as exemplified in FIG. 5. Since the unbalanced tree has a leaf that does not have un-matched adjacent to itself, the tree needs to be propagated to higher heights until it finds a match. In the given example, the last leaf does not find a match until the last hash operation. Therefore, the stack memory hangs when the last leaf arrives on the stack.

In XMSS, the L-tree has an unbalanced tree structure and therefore it is typically implemented with the solution exemplified in FIG. 3.

With the foregoing and other objects in view, there is provided, in accordance with the invention, a computer-implemented method for computing an unbalanced L-tree for hash-based signatures used in post-quantum cryptographic authentication is disclosed that includes providing a computer with at least one processor operably configured to carry out a post-quantum cryptographic authentication session and having computer-readable instructions to generate a root of an unbalanced L-tree in the post-quantum cryptographic authentication session, computing a maximum 2ⁿ number of leaf node pairs formed on the unbalanced L-tree and hashing each pair of adjacent leaf nodes forming the maximum 2ⁿ number of leaf node pairs with a stacked-based root implementation until reaching an unpaired stacked node output, and then subjecting remaining leaf nodes formed on the unbalanced L-tree with an L-tree-based root implementation and computing the remaining leaf nodes with the unpaired stacked node output to generate the root of the unbalanced L-tree formed as part of the post-quantum cryptographic authentication session.

In accordance with another feature, an embodiment of the present invention includes computing the maximum 2ⁿ number of leaf node pairs formed on the unbalanced L-tree by calculating a 2ⁿ amount of the leaf nodes less than a total of leaf nodes formed on the unbalanced L-tree.

In accordance with another feature, an embodiment of the present invention also includes generating the root of the unbalanced L-tree formed as part of a key generation routine in the post-quantum cryptographic authentication session and computing the remaining leaf nodes with the unpaired stacked node output to generate the root of the unbalanced L-tree formed as part of the key generation routine in the post-quantum cryptographic authentication session.

In accordance with a further feature of the present invention, the stacked-based root implementation, the L-tree-based root implementation, and the computing of the remaining leaf nodes uses a thash_h operation in XMSS.

Also in accordance with the present invention, an embodiment of the present invention includes a method for computing an unbalanced L-tree for hash-based signatures used in post-quantum cryptographic authentication that includes providing a memory unit having initialized WOTS chain output forming a plurality of leaf nodes in an unbalanced L-tree in a post-quantum cryptographic authentication session, generating, with an operational task of the memory unit, a root of the unbalanced L-tree in the post-quantum cryptographic authentication session, computing, with an operational task of the memory unit, a maximum 2ⁿ number of leaf node pairs formed on the unbalanced L-tree and hashing each pair of adjacent leaf nodes forming the maximum 2ⁿ number of leaf node pairs with a stacked-based root implementation until reaching an unpaired stacked node output, and subjecting, with an operational task of the memory unit, remaining leaf nodes formed on the unbalanced L-tree with an L-tree-based root implementation and computing the remaining leaf nodes with the unpaired stacked node output to generate the root of the unbalanced L-tree formed as part of the post-quantum cryptographic authentication session.

In accordance with yet another feature, an embodiment of the present invention also includes computing, with the operational task of the memory unit, the maximum number of leaf node pairs formed on the unbalanced L-tree by calculating a 2ⁿ amount of the leaf nodes less than a total of leaf nodes formed on the unbalanced L-tree.

In accordance with yet another feature, an embodiment of the present invention also includes generating the root of the unbalanced L-tree formed as part of a key generation routine in the post-quantum cryptographic authentication session and computing the remaining leaf nodes with the unpaired stacked node output to generate the root of the unbalanced L-tree formed as part of the key generation routine in the post-quantum cryptographic authentication session.

Although the invention is illustrated and described herein as embodied in a computer-implemented method for computing unbalanced L-trees efficiently for hash-based signatures used in post-quantum cryptographic authentication, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Furthermore, there is no intention to be bound by any expressed or implied theory presented in the preceding technical field, background, brief summary or the following detailed description.

As used herein, the terms “about” or “approximately” apply to all numeric values, whether or not explicitly indicated. These terms generally refer to a range of numbers that one of skill in the art would consider equivalent to the recited values (i.e., having the same function or result). The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

### DETAILED DESCRIPTION

While the specification concludes with claims defining the features of the invention that are regarded as novel, it is believed that the invention will be better understood from a consideration of the following description in conjunction with the drawing figures, in which reference numerals are carried forward. It is to be understood that the disclosed embodiments are merely exemplary of the invention, which can be embodied in various forms.

The present invention provides an architecture and methodology that provides a technical solution to prevent or significantly reduce memory inefficiencies in L-tree implementations for unbalanced L-trees used in XMSS. This solution combines both L-tree-based and stack-based root generation methods.

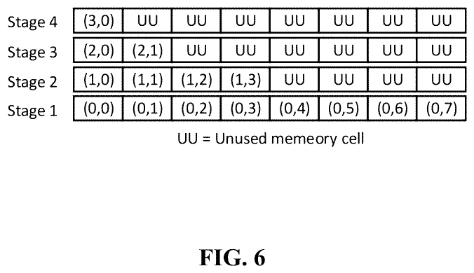

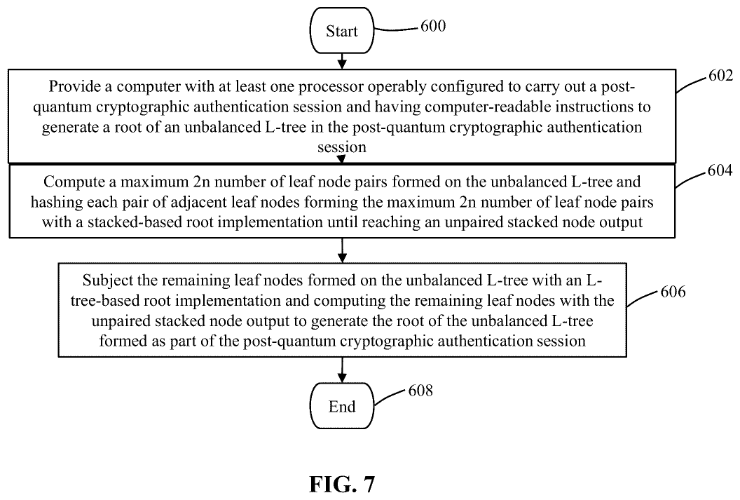

With reference to FIG. 6, a memory usage sequence is depicted as a result of the present invention, namely an architecture and methodology that requires only one stack and one L-tree based memory structure. FIG. 7 is a process flow diagram depicting an exemplary computer-implemented method for computing an unbalanced L-tree for hash-based signatures used in post-quantum cryptographic authentication. FIG. 6 will be described in conjunction with the process flow chart of FIG. 7. Although FIG. 7 shows a specific order of executing the process steps, the order of executing the steps may be changed relative to the order shown in certain embodiments. Also, two or more blocks shown in succession may be executed concurrently or with partial concurrence in some embodiments. Certain steps may also be omitted in FIG. 7 for the sake of brevity. In some embodiments, some or all of the process steps included in FIG. 7 can be combined into a single process.

The process may begin at step 600 and may proceed directly toward step 602 of providing a computer with at least one processor operably configured to carry out a post-quantum cryptographic authentication session and having computer-readable instructions to generate a root of an unbalanced L-tree in the post-quantum cryptographic authentication session. When implemented in hardware, the process for computing an unbalanced L-tree for hash-based signatures used in post-quantum cryptographic authentication would include providing a memory unit having initialized WOTS chain output (exemplified in FIG. 1) forming a plurality of leaf nodes in an unbalanced L-tree in a post-quantum cryptographic authentication session. Additionally, the process may include generating, with an operational task of the memory unit, a root of the unbalanced L-tree in the post-quantum cryptographic authentication session.

The next step 604 may include computing (with the same or different operational task of the memory unit that is separate from the operational task of the memory unit for generating the root) a maximum 2ⁿ number of leaf node pairs formed on the unbalanced L-tree and hashing each pair of adjacent leaf nodes forming the maximum 2ⁿ number of leaf node pairs with a stacked-based root implementation until reaching an unpaired stacked node output. Said differently, step 604 may include computing a maximum 2ⁿ number of leaf nodes formed on the unbalanced L-tree and then hashing each pair of adjacent leaf nodes forming the maximum even number of leaf node pairs with a stacked-based root implementation until reaching an unpaired stacked node output. Said further, the architecture and methodology may include computing the hashing for the tree leaves that support the balanced tree structure, or computing the hashing with a stack-based root generation until the leaf number N, where N can be a power of 2, but smaller than the number of total leaves. Said another way, the process may include computing the maximum even number of leaf node pairs formed on the unbalanced L-tree by calculating a 2ⁿ amount of the leaf nodes less than a total of leaf nodes formed on the unbalanced L-tree.

Next, the process may include the step 606 subjecting (with the same or different operational task of the memory unit that is separate from the operational task of the memory unit for generating the root) remaining leaf nodes formed on the unbalanced L-tree with an L-tree-based root implementation and computing the remaining leaf nodes with the unpaired stacked node output to generate the root of the unbalanced L-tree formed as part of the post-quantum cryptographic authentication session. Said differently, said step may includes subjecting a remaining leaf node formed on the unbalanced L-tree with a L-tree-based root implementation and computing the remaining leaf node with the unpaired stacked node output to generate the root of the unbalanced L-tree formed as part of the key generation routine in the cryptographic authentication session. Said another way, the process may include generating the root of the unbalanced L-tree formed as part of a key generation routine in the post-quantum cryptographic authentication session and computing the remaining leaf nodes with the unpaired stacked node output to generate the root of the unbalanced L-tree formed as part of the key generation routine in the post-quantum cryptographic authentication session. The stacked-based root implementation, the L-tree-based root implementation, and the computing of the remaining leaf nodes may also use a thash_h operation in XMSS to effectuate implementation of the present invention. The process may conclude at step 608.

For instance, in FIG. 6, the N is eight. Hence, the first eight leaves are computed with stack-based implementation. Then, the remaining leaf node is subjected to hashing that is performed with the L-tree-based implementation method. For the given example, there is an unbalanced tree having 9 leaves. The stack-based implementation can compute only the balanced part (which is exemplified in FIG. 4 with area 300). The balanced part has 8 leaves; thus, the stack implementation requires 3 memory (log2(8)) spaces. However, the last leaf cannot be computed with the stack-based implementation and hence we use an L-tree-based root implementation for it. The last leaf is propagated to the highest height and then computed with stack output. The computation result is the final operation and generates the root.

In XMSS, the largest L-tree has 67 leaves. As such, the present invention requires needs a stack having eight memory locations for the first 64 leaves since stack-based implementation requires log 2(#leaves) memory space. In addition to the stack, the present invention requires three memory locations for the remaining leaves. As a result, the present invention requires 11 memory locations rather than 67. This results in an 83.582% improvement in memory usage and hence is useful for memory-constrained applications which is considered to be costly.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the above-described features.

What is claimed is:

1. A computer-implemented method for computing an unbalanced L-tree for hash-based signatures used in post-quantum cryptographic authentication comprising:
providing a computer with at least one processor operably configured to carry out a post-quantum cryptographic authentication session and having computer-readable instructions to generate a root of an unbalanced L-tree in the post-quantum cryptographic authentication session;
computing a maximum 2ⁿ number of leaf node pairs formed on the unbalanced L-tree and hashing each pair of adjacent leaf nodes forming the maximum 2ⁿ number of leaf node pairs with a stacked-based root implementation until reaching an unpaired stacked node output; and
subjecting remaining leaf nodes formed on the unbalanced L-tree with an L-tree-based root implementation and computing the remaining leaf nodes with the unpaired stacked node output to generate the root of the unbalanced L-tree formed as part of the post-quantum cryptographic authentication session.

2. The computer-implemented method according to claim 1, further comprising:
computing the maximum 2ⁿ number of leaf node pairs formed on the unbalanced L-tree by calculating a 2ⁿ amount of the leaf nodes less than a total of leaf nodes formed on the unbalanced L-tree.

3. The computer-implemented method according to claim 1, further comprising:
generating the root of the unbalanced L-tree formed as part of a key generation routine in the post-quantum cryptographic authentication session; and
computing the remaining leaf nodes with the unpaired stacked node output to generate the root of the unbalanced L-tree formed as part of the key generation routine in the post-quantum cryptographic authentication session.

4. The computer-implemented method according to claim 1, wherein the stacked-based root implementation, the L-tree-based root implementation, and the computing of the remaining leaf nodes uses a thash_h operation in XMSS.

5. A method for computing an unbalanced L-tree for hash-based signatures used in post-quantum cryptographic authentication comprising:
providing a memory unit having initialized WOTS chain output forming a plurality of leaf nodes in an unbalanced L-tree in a post-quantum cryptographic authentication session;
generating, with an operational task of the memory unit, a root of the unbalanced L-tree in the post-quantum cryptographic authentication session;
computing, with an operational task of the memory unit, a maximum 2ⁿ number of leaf node pairs formed on the unbalanced L-tree and hashing each pair of adjacent leaf nodes forming the maximum 2ⁿ number of leaf node pairs with a stacked-based root implementation until reaching an unpaired stacked node output; and
subjecting, with an operational task of the memory unit, remaining leaf nodes formed on the unbalanced L-tree with an L-tree-based root implementation and computing the remaining leaf nodes with the unpaired stacked node output to generate the root of the unbalanced L-tree formed as part of the post-quantum cryptographic authentication session.

6. The computer-implemented method according to claim 5, further comprising:
computing, with the operational task of the memory unit, the maximum number of leaf node pairs formed on the unbalanced L-tree by calculating a 2ⁿ amount of the leaf nodes less than a total of leaf nodes formed on the unbalanced L-tree.

7. The computer-implemented method according to claim 5, further comprising:
generating the root of the unbalanced L-tree formed as part of a key generation routine in the post-quantum cryptographic authentication session; and
computing the remaining leaf nodes with the unpaired stacked node output to generate the root of the unbalanced L-tree formed as part of the key generation routine in the post-quantum cryptographic authentication session.

8. The computer-implemented method according to claim 5, wherein the stacked-based root implementation, the L-tree-based root implementation, and the computing of the remaining leaf nodes uses a thash_h operation in XMSS.
